(19) United States
(12) Patent Application Publication
(10) Pub. No.: US 2005/0033631 A1
(43) Pub. Date: Feb. 10, 2005

(54) Systems and methods for providing benchmark services to customers

(75) Inventors: Marcus Wefers, Heidelberg (DE); Roman Bukary, San Francisco, CA (US)

Correspondence Address: Finnegan, Henderson, Farabow,;Garrett & Dunner, L.L.P., 1300 I Street, N.W., Washington, DC, 20005-3315, US

(73) Assignee: SAP Aktiengesellschaft

(21) Appl. No.: 10/835,318

(22) Filed: Apr. 30, 2004

Related U.S. Application Data
(60) Provisional application No. 60/492,722, filed on Aug. 6, 2003.

(51) Int. Cl. G06F 17/60

(52) U.S. Cl. 705/10

(57) ABSTRACT

Systems and methods are disclosed for providing benchmark services to customers. The services may be provided through a benchmark provider. The benchmark provider may build a benchmark database based on data collected from customers and/or third party sources. The submission of benchmark data can be made optional to the customer and, thus, not a requirement to receive service(s) from the benchmark provider. In addition, the benchmark database may be built as a comprehensive database, such that it is well-populated and provides benchmark data for many or all types of functional areas (e.g., FIN, CRM, SCM, SRM, HR, etc.), industries and/or sizes of companies. Offers for benchmark services may be presented to customers and specific service(s) may be provided in accordance with the service election(s) made by each customer.

### CROSS REFERENCE TO RELATED APPLICATION

This application claims the benefit of U.S. Provisional Patent Application No. 60/492,722, filed Aug. 6, 2003, the disclosure of which is expressly incorporated herein by reference in its entirety.

### BACKGROUND OF THE INVENTION

I. Field of the Invention

The present invention generally relates to electronic data processing. More particularly, the present invention relates to systems and methods for providing benchmark services to customers, such as benchmark data services and/or other service offerings.

II. Background Information

In today's fast changing economic environment, companies are required to monitor and track performance. For instance, medium and large size companies have an increasing need to compare their business performance to their competitors or peer groups. This applies not only to financial metrics, such as sales growth and return on capital employed (ROCE), but also to all other functional areas, such as customer, process and human resources (HR) metrics.

For this purpose, companies often employ the services of benchmark providers and consultants. Benchmark providers offer various types of benchmark data, such as supply chain benchmark data (e.g., Supply Chain Operations Reference (SCOR) metrics). Generally, a benchmark is a point of reference by which something can be measured. A benchmark may comprise a set of conditions against which an item, such as a product, system, process or quantity, is measured. As used herein, the term “benchmark” encompasses any set of standards or averages by which similar items can be compared or analyzed.

Benchmark data has become a critical input factor for performance measurement and strategy management of enterprises. This information is not only used for measurement purposes, but also essential to enable meaningful business planning. Companies need quality information about their competitors, industry, products, markets etc. Benchmarks can be useful to satisfy such needs, and some companies offer benchmark programs for downloading or benchmark testing services through their own web site.

If a company intends to perform benchmark analyses with respect to its competitors, the company must acquire benchmark data on its own or consult a benchmark provider. This is a time consuming task, even if the company uses an enterprise resource planning (ERP) software. Further, compatibility problems may arise if the data does not fit to the format required by the company's ERP software.

Companies that wish to acquire data from a benchmark provider are typically required to contribute to a benchmark study. This means that a company must share their internal business or process data with the benchmark provider. Through customer data contributions, the provider is able to increase its benchmark database and, thus, increase the value of its services. However, for companies not willing to comply with this requirement, data is not exchanged and the benchmark provider will then often refuse to offer its services to these companies.

Other difficulties also exist for companies that require benchmark data. For example, benchmark service offerings are typically expensive and benchmark providers with high quality standards are difficult to find. The lack of quality is partly because there are no existing regulations to ensure appropriate service and quality standards by providers. In addition, even if the benchmark provider is reliable, most benchmark providers only deal with benchmark data from one functional area and, furthermore, the data they offer can have strong regional dependencies. This is problematic, especially for companies who require benchmark data from multiple functional areas and/or need data that is not influenced by regional dependencies.

Another problem is the lack of data formats for storing and exchanging benchmark data. This can lead to slow and cumbersome integration of benchmark data into a company's ERP software or reporting environment. In addition, while these environments are supported by leading software providers, many benchmark providers are unwilling to collaborate with software vendors to define common data structures or formats in order to improve the exchange of data with the software vendor's customers.

In view of the foregoing, there is a need for improved systems and method for providing benchmark services. For instance, there is a need for improved systems and methods for collecting data to build a benchmark database and providing benchmark services to companies. Furthermore, there is a need for improved benchmark resources that are reliable and comprehensive for many or all types of functional areas, industries and/or sizes of companies. Moreover, there is also a need for improved systems and methods for exchanging benchmark data between benchmark providers and customers.

### SUMMARY OF THE INVENTION

Consistent with embodiments of the present invention, systems and methods are disclosed for providing benchmark services to customers. Embodiments of the invention include systems and methods that are adapted to collect benchmark data and build a benchmark database. To collect data for the database, requests for data may be sent to customers and/or third party resources. Embodiments of the invention also include systems and methods for offering benchmark services to customers and providing such services based on the service offering(s) selected by each customer.

In accordance with an embodiment of the invention, systems and methods are provided for establishing benchmark services for customers. The services may be provided through a benchmark provider. The benchmark provider may be established as a new company or as a business unit of an existing company. The benchmark provider may build a benchmark database based on data collected from customers and/or third party sources. The submission of data can be made optional to the customer and, thus, not a requirement to receive service(s) from the benchmark provider. In addition, the benchmark database may be built as a comprehensive database, such that it is well-populated and provides benchmark data for many or all types of functional areas, industries and/or sizes of companies. Moreover, offers for benchmark services may be presented to customers and specific service(s) may be provided in accordance with the service election(s) made by each customer.

According to another embodiment of the present invention, a method is disclosed for providing benchmark services to customers. The method may comprise: collecting data from a plurality of customers; processing collected data from each customer to determine if the data is valid; building a comprehensive benchmark database based on the collected data determined to be valid, the comprehensive benchmark database including data for at least a plurality of functional areas; presenting benchmark service offers to customers, the offers including the option to select at least one type of benchmark service to receive data from the comprehensive benchmark database; and providing benchmark services to customers in accordance with the benchmark services selected by each customer.

In accordance with yet another embodiment of the invention, a method is disclosed for providing benchmark services to customers, wherein the benchmark services are provided by a benchmark provider. The method may comprise: presenting requests for benchmark data to a plurality of customers, each request including a request to contribute data that may be declined by a customer without influencing the customer's ability to receive benchmark services from the benchmark provider; collecting data from each of the plurality of customers who accept the request to contribute data; building a benchmark database based on the data collected from the plurality of customers, wherein data from the benchmark database provides support for the benchmark services; presenting offers to customers, the offers including the option to select at least one type of benchmark service; and providing benchmark services to customers in accordance with the benchmark services selected by each customer.

In accordance with still another embodiment of the invention, a system is disclosed for providing benchmark services to customers. The system may comprise: a comprehensive benchmark database comprising benchmark data for at least one of: a plurality of functional areas, a plurality of industries, and a plurality of company sizes; and a benchmark system adapted to administer and provide benchmark services to customers, wherein the benchmark services are supported by the comprehensive benchmark database. As disclosed herein, the benchmark system may include: data collection and management means for collecting data for the comprehensive benchmark database; and data exchange means for providing benchmark data to a customer in accordance with a service offering selected by the customer.

Additional embodiments of the invention are directed to a system for providing benchmark services, wherein the system comprises: means for collecting data from a plurality of customers; means for building a comprehensive benchmark database based on the data collected from the plurality of customers, the comprehensive benchmark database including data for at least a plurality of functional areas; means for presenting offers to customers, the offers including the option to select at least one type of benchmark service to receive data from the comprehensive benchmark database; and means for providing benchmark services to customers in accordance with the benchmark services selected by each customer.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary diagram for illustrating aspects related to providing benchmark services, consistent with embodiments of the invention;

FIG. 2 illustrates an exemplary system environment for implementing embodiments of the invention;

FIG. 3 is a block diagram of an exemplary benchmark system, consistent with embodiments of the invention;

FIG. 4 is a flowchart of an exemplary method for establishing a benchmark service, consistent with embodiments of the invention;

FIG. 5 is a flowchart of an exemplary method for collecting data and building a benchmark database, consistent with embodiments of the invention; and

FIG. 6 is a flowchart of an exemplary method for presenting offers to customers and providing benchmark services in accordance with the service offerings selected by customers.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Embodiments of the present invention are directed to systems and methods for providing benchmark services to customers. As used herein, the term “customer” broadly refers to any person, business, organization, group, agency or other entity that uses benchmark data and/or other service offerings from a benchmark provider. Further, the term “benchmark provider” generally refers to any person, business, organization, group, agency or other entity that provides benchmark data and/or other related services to customers. For example, a benchmark provider may be a company or business entity that provides services to customers such as: benchmark data and benchmark definitions (i.e., measures or rules for the calculation and interpretation of benchmark data); participation in benchmark studies; consulting; and/or advanced analysis of benchmark data.

Consistent with embodiments of the invention, the relationship between the benchmark provider and each customer may vary. For example, the customer may be a pre-existing customer of the benchmark provider, or may be a new or potential customer of the benchmark provider. Further, the customer may be a customer that both contributes data and receives benchmark data from the benchmark provider. Alternatively, the customer may be a customer that only contributes data to the benchmark provider or may be a customer that only receives benchmark data from the provider. Other relationships are possible and may vary depending on the environment in which the invention is implemented.

Embodiments of the invention may be utilized to establish benchmark services for customers. Such services may be administered through a benchmark provider. The benchmark provider may be a new business venture that is launched by a group of individuals, investors, entrepreneurs and/or any other entities. Alternatively, the benchmark provider may be a new business unit or subsidiary of a company with an established customer base. Under this approach, the benchmark provider may offer benchmark services to the company's existing customers, which may compliment other services or goods provided from the company. Additionally, data from the existing customers may be used to populate and create a large-scale or comprehensive benchmark database. The advantages of this arrangement, as well as others, will become be apparent to those skilled in the art in view of the present disclosure.

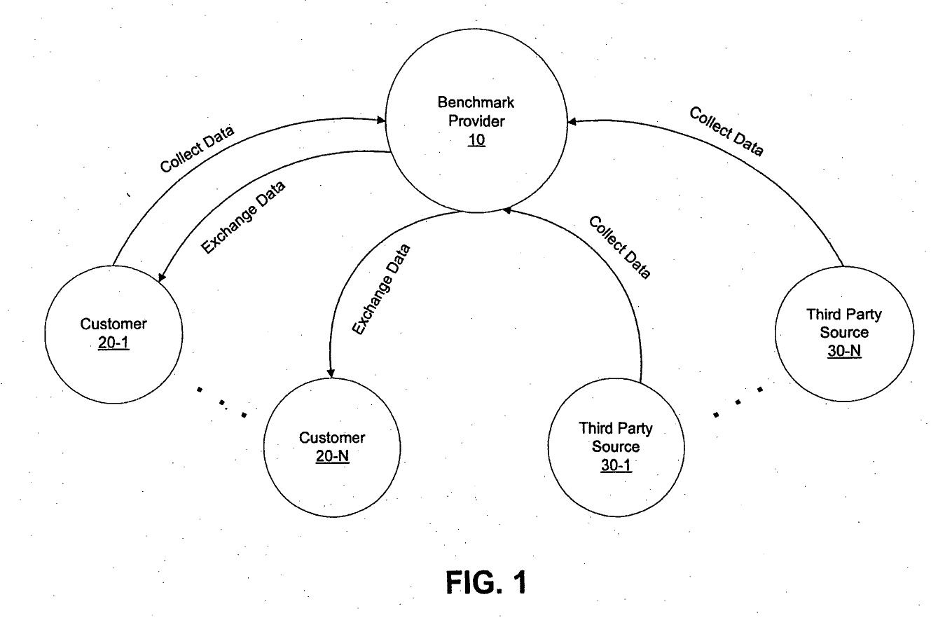

FIG. 1 illustrates certain aspects related to providing benchmark services, consistent with embodiments of the invention. In the example of FIG. 1, various entities are shown, including a benchmark service provider 10, a plurality of customers 20-1 to 20-N and a plurality of third party sources 30-1 to 30-N. Generally, benchmark provider 10 collects data and provides benchmark data and/or other service offerings to customers 20-1 and 20-N. As stated above, the customers may be existing customers of the benchmark provider, or may be new or potential customers of the provider. In some cases, a customer (such as customer 20-1) may contribute data, as well as receive benchmark data from benchmark provider 10. In other cases, the customer (such as customer 20-N) may only receive data from benchmark provider 10. Other variations are also possible, such as a customer (not shown) that only contributes data to benchmark provider 10.

Benchmark provider 10 may be an independent company or may be created as a new business unit of an existing company that has an established customer base. While only one benchmark provider 10 is illustrated in FIG. 1, embodiments of the invention are not limited to this example. Thus, for example, any number of benchmark providers may be provided or set-up to facilitate the needs of customers. Similarly, the specific number of the entities illustrated in FIG. 1 should not be deemed restrictive of the scope of the invention and, thus, any number of customers, third party sources and/or other entities may be provided.

To build and establish a benchmark database, provider 10 may request and collect data from customers 20-1 to 20-N. The data may comprise internal business process or performance data, as well as other relevant customer data. Further, the request and collection of data may be made under various conditions. For example, the data may be collected from customers as part of a survey, a benchmark study or another collection process. Further, the submission data may be optional to each customer. Thus, in one embodiment, the customer is not required to contribute data in order to receive services from the benchmark provider. Additionally, the benchmark provider 10 may guarantee confidentiality, including a guarantee to the customer that any data of the customer that is confidential or sensitive will not be compromised or disclosed to the public. To encourage data collection, discounts or incentives may also be offered to customers, such as predetermined discounts on benchmark service fees for customers who submit data to populate the benchmark database.

In embodiments where the benchmark provider 10 is established as a business unit or subsidiary of an existing company, customers of the company may be more encouraged to contribute data to the benchmark provider, especially where the company has a good business reputation or is accepted as a trusted advisor or other entity. Examples of such companies include established software vendors who provide business software to customers, large accounting or consulting firms that provide services to customers, banks and other types of financial institutions, etc. Furthermore, where the company has a large or diverse customer base, the benchmark provider's ability to collect data and build a large-scale or comprehensive database is enhanced.

As further disclosed herein, a comprehensive database can be built that is not only more reliable, but also covers many or all types of industries, company sizes and functional areas (e.g., financials (FIN), customer relationship management (CRM), supply chain management (SCM), supplier relationship management (SRM), HR, etc.). To provide such a comprehensive database, data from many customers (e.g., thousands, tens of thousands or more) may be required.

To build a benchmark database, benchmark provider 10 may also collect data from other sources, such as the one or more third party sources 30-1 to 30-N shown in FIG. 1. The third party sources may represent various data collection channels or sources other than customers 20-1 to 20-N to populate the benchmark database. Examples of third party sources include data collected from companies or other business entities, as well as data from third party benchmark studies, surveys, data mining reports, electronic watch and collect data, etc. In addition, to facilitate locating these sources, automated search tools or search bots may be provided to identify relevant third party sources based on listings or other posting on, for example, the Internet. Such tools may be used to efficiently identify and acquire relevant data or sets of data from third party sources, including individual or regional benchmark providers.

Various conditions may apply to the collection of data from third party sources 30-1 to 30-N. For example, benchmark provider 10 may guarantee confidentiality to a third party source in a similar manner to that provided to customers. Further, the collection of the data from the third party sources may be fee based, with any such fees or purchase costs being borne by benchmark provider 10.

After collecting data from customers 20-1 to 20-N and/or third party sources 30-1 to 30-N, benchmark provider 10 may process and format the data. For example, where needed, collected data may be processed so that it is validated, parsed and/or cleansed. In one embodiment, a validation procedure is used to eliminate collected data that is deemed to be invalid because it is inconsistent with comparable data (e.g., it deviates from an average or valid range). Further, the data may be placed into a predetermined data format. Consistent with an embodiment of the invention, one or more predetermined data formats may be used by the benchmark provider to facilitate the electronic storage and exchange of benchmark data. The predetermined data format(s) may be consistent with an extrinsic standard of a software vendor (such as SAP AG of Walidorf, Germany) or another entity which defines an electronic data structure for handling or storing benchmark data within a software-based environment or application. The software-based environments or applications may be utilized by customers to support business processes and may comprise, for example, enterprise resource planning (ERP) or strategic enterprise management (SEM) software. By way of example, the predetermined format may be consistent with a SAP® business warehouse (BW), Infocube designed for SAP® systems and software environments.

In one embodiment, the collected data is processed and benchmark calculations are made. Conventional analytical processing may be provided to permit analysis and comparison of data against best-in-class, industry average, and competitors. Further, various attributes may be assigned to the data (e.g., company size, industry, region, etc.). Also, any confidential information of a customer or third party (e.g., company name, address, etc.) may be removed.

To exchange benchmark data, provider 10 may enter into service contracts with customers 20-1 to 20-N. Different service levels may be offered to a customer, as well as other service offering (e.g., industry reports, benchmark studies, etc.). The service level offerings may vary based on data volume and/or level of sophistication. Further, a service contract may require a specific fee to be paid by a customer. The service fee may vary according to the service level elected by the customer. In one embodiment, the service fee is a predetermined flat fee. In another embodiment, the service fee is a fee based on usage.

When exchanging or providing benchmark data with a customer, various arrangements may be provided. For example, requested benchmark data may be copied to a computer readable medium (such as a disk or CD-ROM) and mailed to the customer. Additionally, or alternatively, benchmark provider 10 may permit customers to electronically request and receive benchmark data through, for example, a secure modem connection over a communications network or a password protected web site on the Internet. To implement this approach, the benchmark provider may operate a server that controls access to the benchmark database. A firewall and/or other appropriate measures may also be used to maintain confidentiality and guarantee data security.

The availability of benchmark data for the analysis can be implemented in various ways. For example, external benchmark data from a benchmark provider may be transferred to a customer for storage and analysis. This enables the customer to use the external data within analytical applications such as a balanced scorecard, management cockpit, value driver trees, business planning and simulation, reporting, financial analytics, customer relationship management analytics, SCM analytics or human capital management analytics, etc. Alternatively, the benchmark provider may permit access to the data to customers directly via web-based services. The web-based services may offer in-depth analytical services based on the data from the benchmark provider's database. Additionally, or alternatively, the benchmark provider may offer their data plus analytical tools via CD-ROM delivery for viewing at the customer site.

As will be appreciated by those skilled in the art, any suitable combination of hardware, software and/or firmware may be utilized to implement the features of FIG. 1. For example, the various entities of FIG. 1 may be provided with computer hardware and/or software to facilitate the exchange, processing and/or storage of benchmark data. Such hardware may include personal computers, laptops, workstations, and servers, as well as storage devices and/or commercially available databases. Further, the software may comprise software that is executed by computer hardware to provide an operating environment and/or suitable applications that run on the operating environment to provide the functionality described herein. To enable the electronic collection and exchange of data, the entities depicted in FIG. 1 may also be provided with communication hardware and/or software with access to a network, such as a telephony-based network, a cable network and/or the Internet. By way of example, to implement the exchange data through a web site, each customer may have a computer with access to the Internet and a navigation application such as a web browser.

Embodiments of the invention according to FIG. 1 may also be embodied as an article of manufacture, such as a computer-software product. In such embodiments, programming instructions may be provided on a computer readable medium or carrier signal and be adapted to perform one or more features of the invention when executed with a computer-based platform.

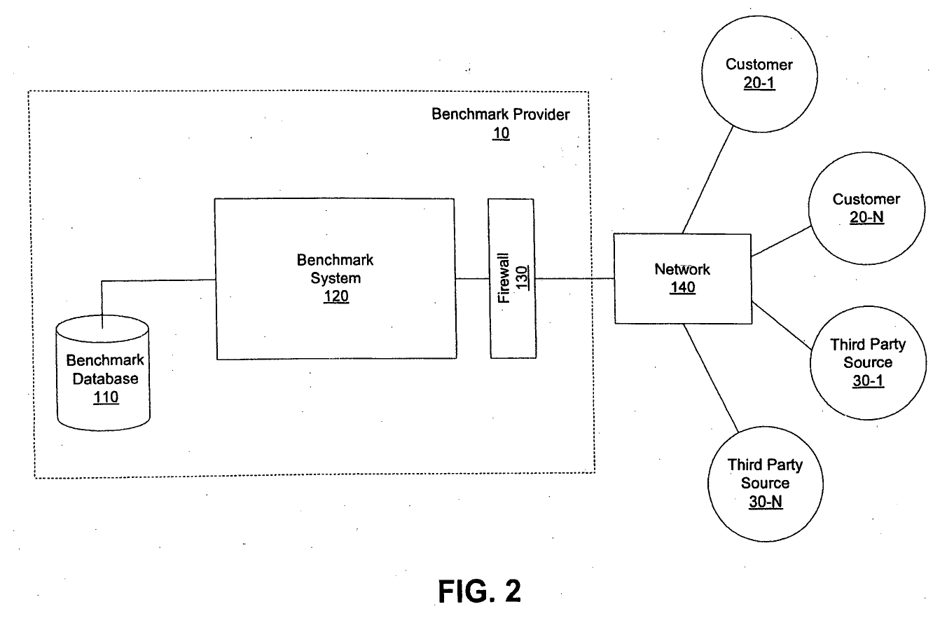

By way of a non-limiting example, FIG. 2 illustrates an exemplary system environment for implementing embodiments of the invention. As shown in FIG. 2, benchmark provider 10 is configured to electronically collect and exchange benchmark data through a network 140. Network 140 may comprise any suitable combination of wired and/or wireless networks. Examples of wired networks include telephony-based networks and cable networks. Examples of wireless networks include mobile, cellular and satellite communication networks. In one embodiment, network 140 comprises the Internet and customers 20-1 to 20-N and third party sources 30-1 to 30-N have access to the Internet through Internet Service Providers (ISPs) or other means. Further, an extranet or secure web server may be implemented to facilitate communication with benchmark provider 10.

As further shown in FIG. 2, benchmark provider 10 includes a benchmark database 110 and a benchmark system 120. Benchmark database 110 may be implemented through conventional storage devices or commercially available databases. Examples of commercially available databases include SAP® DB, IBM® Universal DB2 and iSeries, Informix® Dynamic Server, Microsoft® SQL Server and Oracle® 9iDatabase. Further, to protect the resources of benchmark provider 10 and provide data security, a firewall 130 and/or other suitable hardware and software may be provided.

Generally, benchmark provider 10 communicates with customers 20-1 to 20-N and third party resources 30-1 to 30-N through network 140. As stated above, to populate benchmark database 110, benchmark provider 10 may request and collect data from customers 20-1 to 20-N. The request and collection of data may occur entirely over network 140 using, for example, e-mail communication, conventional file formats and transfer protocols and/or a secure server or web site. Optionally, benchmark provider 10 may also collect data from one or more third party sources 30-1 to 30-N via network 140. The third party sources may represent various additional data collection channels or sources to populate the benchmark database. Examples of third party sources include benchmark studies, surveys, data mining reports, electronic watch and collect data, etc.

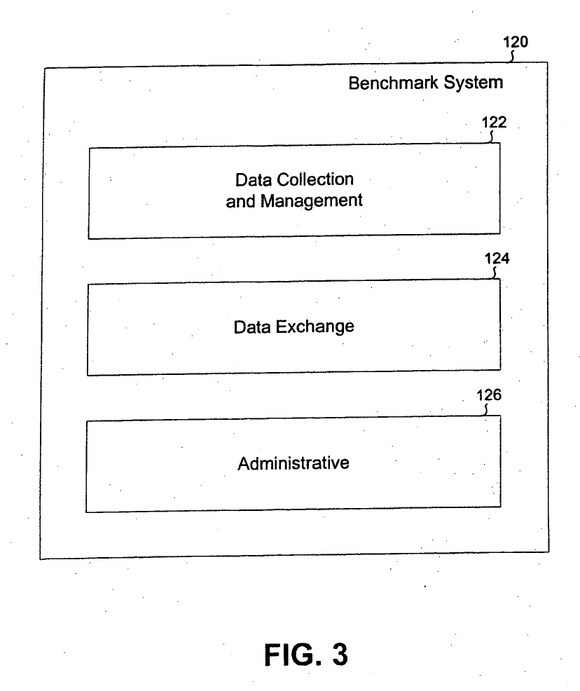

Benchmark system 120 may comprise one or more computer-based platforms (personal computers, workstations, servers, etc.) configured with software to perform specific functions associated with benchmark provider 10. By way of example. FIG. 3 illustrates the functions that may be performed by benchmark system 120. These functions include: data collection and management 122; data exchange 124; and administration 126. Consistent with embodiments of the invention, one or more software components may be provided to perform these functions when executed by a computer-based platform. Alternatively, or additionally, the software components may be combined into a software product with programming instructions for performing one or more of the functions of FIG. 3. Further, as will be appreciated by those skilled in the art, the functions identified in FIG. 3 are merely exemplary, and substitutions, modifications and/or additions may be made to benchmark system 120 without departing from the spirit and scope of the present invention.

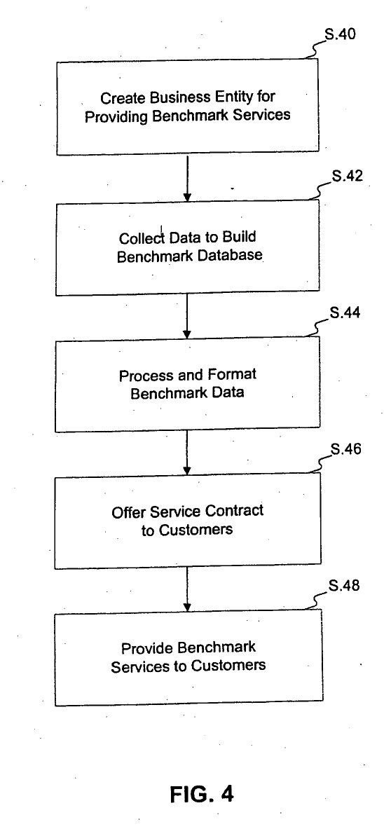

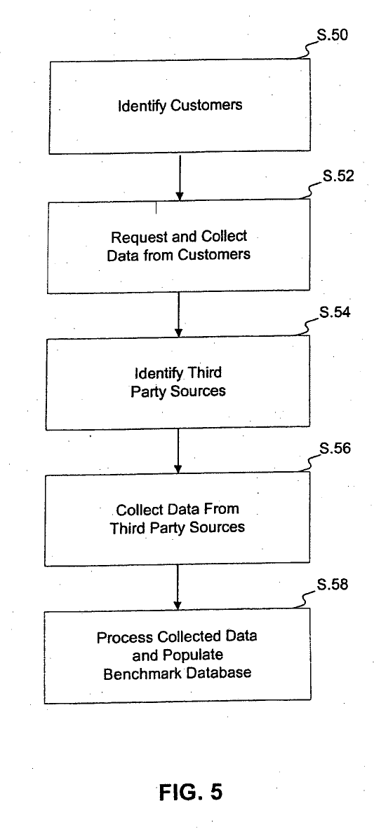

Data collection and management 122 includes all functions associated with the collection and management of data for benchmark database 110. This includes requesting and collecting data from customers 20-1 to 20-N, as well as collecting data from third party sources 30-1 to 30-N. Data collection and management 122 may also include data processing functions, such as data validation, cleansing and formatting, as well as benchmark data calculations and reports. Data security and maintenance functions may also be provided to guarantee the security and reliability of the data in benchmark database 110. The above-listed functions are examples and provided for purposes of illustration. Further examples and features for implementing data collection and management 122 are described herein with reference to, for example, FIGS. 4 and 5.

Data exchange 124 includes functions for supporting the exchange of benchmark data with customers. These functions may include the processing of requests from customers, accessing benchmark database for data retrieval and the forwarding of benchmark data to customers via network 140 or through other suitable means. Data exchange 124 may also include functions for facilitating other benchmark service offerings, such as the purchase of industry reports or benchmark studies. Additionally, data exchange 124 may include functions for keeping track of each customer's service usage (e.g., by data volume or service level usage) and reporting the same to administrative 126 for the purposes of billing, etc. The above-listed functions are merely examples and do limit the functions that may be provided as part of data exchange 124. Further examples and features for implementing data exchange 124 are described herein with reference to, for example, FIG. 4.

Administrative 126 includes administrative functions associated with collecting and providing benchmark data. For example, administrative 126 may include functions for searching and identifying customers and/or third party sources to collect benchmark data. As part of these functions, administrative 126 may be responsible for generating different types or forms of data collection requests and providing the generated requests to data collecting and management 122 so that they may be presented to customers. As stated above, the data collection requests may include incentives or discounts, such as a discount on benchmark service for submitting data for the database. These incentives or discounts may vary according to attributes associated with each company (company size, industry, location, etc.). Administrative 126 may also include functions for creating and managing customer accounts, as well as administrative details for providing benchmark services to customers, including customer billing and payment collection functions. Additional examples and features for implementing data collection and management 126 are described herein with reference to, for example, FIGS. 4, 5 and 6.

FIG. 4 is a flowchart of an exemplary method for establishing benchmark services for customers, consistent with embodiments of the invention. As illustrated in FIG. 4, a business entity is created to provide benchmark services to customers (S.40). The benchmark services may include services for exchanging or providing benchmark data, as well as other service offerings. The business entity or “benchmark provider” for these services may be established as an independent company. For example, a group of individuals or investors may establish a new company for providing benchmark services. Alternatively, the benchmark provider may be established as a business unit or subsidiary of an existing company.

In embodiments where the benchmark provider is a business unit or subsidiary of an existing company, customers of the company may be more encouraged to contribute data to the benchmark provider, especially where the company has a good business reputation or is accepted as a trusted advisor or other entity. Examples of such companies include established software vendors who provide business software to customers, large accounting or consulting firms that provide services to customers, banks and other types of financial institutions, etc. Furthermore, where the company has a large or diverse customer base, the benchmark provider's ability to collect data and build a large-scale or comprehensive database is enhanced.

Data for the benchmark database is collected (S.42). As stated above, benchmark data may be collected from customers and, optionally, third party sources. Various approaches may be employed to collect benchmark data as part of step S.42. For example, consistent with embodiments of the invention, data may be collected from customers as part of a survey, a benchmark study or another collection process. Further, the request for benchmark data may be provided as an option that can be accepted or declined by a customer. Thus, for example, a customer may still receive benchmark data and other services from the benchmark provider even though the customer declined to contribute its own benchmark data to the database. Incentives may be provided to encourage the submission of data from a customer. Examples of incentives include discounts on service offerings from the benchmark provider, including discounts on service contracts for benchmark data. Other incentives may also be implemented, such as payment for data contributed by the customer. “Payment” may take various forms, including a check or electronic deposit, a redemption coupon toward the purchase of services from the benchmark provider, complimentary reports or studies, as well as any other item of value. The above approaches are merely examples. Further examples and approaches for collecting benchmark data are described herein with reference to, for example, FIG. 5.

In accordance with an embodiment of the invention, benchmark data may be collected in order to build a comprehensive benchmark database. As used herein, the term “comprehensive” means that the database is well populated and includes many or all relevant attributes for customers. To this end, data may be collected to build a very large- or massive-scale benchmark database, with contributions from many customers and/or third party sources (e.g., thousands, tens of thousands or more). When built, the comprehensive benchmark database may include benchmark data for many or all relevant types of functional areas (e.g., FH, CRM, SCM, SRM, HR, etc.). The data may also be representative of benchmark data for a diverse range of companies, including companies of different sizes, locations and/or industries. With a comprehensive benchmark database, more reliable data can be provided to customers and such data may be sufficiently robust so that is not influenced by, for example, regional dependencies. In addition, the database may permit customers to request benchmark data according to different attributes, such as industry and company size. Accordingly, comprehensive benchmark databases, according to embodiments of the invention, can provide a complete solution and enable customers to avoid the need to rely upon multiple benchmark providers.

Data collected for the benchmark database may be processed and formatted (S.44). For example, raw data may be validated, cleansed or parsed, and any confidential or sensitive information may be removed. Where needed, the data may also be formatted or structured into one or more predetermined data format(s). As disclosed herein, the predetermined data format may be consistent with an extrinsic standard set by a software vendor or another entity (such as a standards setting body). The extrinsic standard may define an electronic data structure for handling and storing benchmark data in a software-based environment or application. By way of example, the predetermined format may be consistent with a SAP® business warehouse (BW), Infocube, designed for SAP® systems and software environments.

In addition to formatting the data, various benchmark calculations may be made and the data may be analyzed to add attributes (e.g., industry, company size, region, etc.) to facilitate data organization and/or retrieval. As will be appreciated by those skilled in the art, other processing may be performed as part of step S.44. Further examples will be evident from this disclosure, including from the description for the exemplary method of FIG. 5.

After building the benchmark database, offers for benchmark service(s) may be presented to customers (S.46). The customers may be existing, new or potential customers of the benchmark provider. In cases where the benchmark provider is established as a business unit of an existing company, the customers may be existing customers of the company. Such an arrangement can provide a good customer base for populating the benchmark database and/or presenting offers for benchmark services. As part of step S.46, offers may be presented to customers using electronic communication (e-mail, pop-up or banner advertisements, etc.) or printed media (letters, flyers, solicitations). In the case of printed media, the offers may be sent by mail, posted or distributed by any suitable means. The offer may include a service contract with options to elect different services. By way of example, offers for benchmark data services may be provided according to different service levels. These services levels may vary according to data volume usage or level of sophistication. The fees associated with each service option may be indicated in the offer presented to the customer. As disclosed herein, services fees can take any form, such as flat fees, usage fees, and the like.

Benchmark services may be provided to a customer according to the service(s) that are elected by the customer (S.48). In one embodiment, customers may respond to a service contract offer by notifying the benchmark provider of the services that they are interested in receiving. The response from a customer may be sent using electronic communication (by email, submission of a response page on a web site, etc.) or by any other means (mailed response card, verbal instructions by telephone, etc.). For each customer, a customer account may be created for billing and other administrative purposes. Further, each customer may be notified by the benchmark provider to confirm the service election(s) and to provide information concerning the service. For purposes of data security, each customer may also be required to have a username and password to log-on to a secure web site or server. Other conventional security measures may be implemented, as needed. Once the customer is set-up, benchmark data and/or other services may be provided to the customer.

FIG. 5 is a flowchart of an exemplary method for collecting benchmark data and building a benchmark database. Consistent with an embodiments of the invention, the database may be built as a comprehensive database for providing benchmark services. Such a database may be well populated and provide many or all types of attributes that can be selected by a customer, including functional areas, industries and/or company sizes. In addition, benchmark data may be formatted in accordance with an extrinsic standard to permit easier exchange of data between the benchmark provider and the customer, as well as faster integration of the data into the operating environment or applications of the customer.

As shown in FIG. 5, customers are first identified by the benchmark provider (S.50). As part of this process, a target list of customers may be developed. Customers may be identified for each industry group to be supported by the database. Further, companies with different attributes may be identified according to, for example, size, revenue and/or region. Additionally, to ensure data reliability and robustness, the list may be developed such that a large number of companies are targeted (e.g., thousand, tens of thousands or more).

In one embodiment, the benchmark provider is created as a business unit of a company with an established and/or diverse customer base. In such cases, the list of identified customers may include customers of the company. Other identified customers (new or potential) may be used to supplement this list. In either case, the benchmark provider's ability to identify customers and collect data may be enhanced due to the existing customer base of the company.

As further shown in FIG. 5, each identified customer is presented with a request for benchmark data (S.52). The request may be presented to the customer using any suitable communication means, such as email, facsimile, telephone, mailed printed materials, etc. Further, consistent with an embodiment of the invention, the request for benchmark data may be made “optional” to enable the customer to accept or decline the request without any consequences. Thus, for example, a customer may still receive benchmark data and other services from the benchmark provider even though the customer declined to contribute its benchmark data in response to the request.

To encourage the submission of data from customers, various approaches may be implemented. For example, confidentiality may be guaranteed to the customer, including a guarantee that the customer's data will not be shared with others or distributed in any way that would compromise the confidentiality of the information. Additionally, or alternatively, incentives may be provided to the customer, such as discounts on service offerings from the benchmark provider or other entities. In one embodiment, a discount on benchmark data services are offered to customers willing to submit data. Other incentives may also be implemented, such as payments for data contributed by the customer. As disclosed herein, a “payment” may take various forms, including a check or electronic deposit, a redemption coupon toward the purchase of services from the benchmark provider, complimentary reports or studies, as well as any other item of value.

As part of step S.52, the benchmark provider may collect data from customers who responded to the requests. The data may be collected electronically, such as by email or downloading to a secured web site, or through other suitable means, such as by disk or CD-ROM copy mailed to the benchmark provider. To ensure data security, the data files may be password protected and/or encrypted using well-known encryption techniques. The above-listed approaches are merely examples, other techniques for collecting the data may be employed, consistent with embodiments of the invention.

In addition to sending requests to customers, third party sources may also be identified to gather benchmark data (S.54). The third party sources may represent additional data collection channels or sources to populate the benchmark database. Examples include data collected from companies or other business entities, as well as data from third party benchmark studies, surveys, data mining reports, electronic watch and collect data, etc. In addition, to facilitate locating these sources, automated search tools or search bots may be provided to identify relevant third party sources based on listings or other posting on, for example, the Internet. Such tools may be used to efficiently identify and acquire relevant data or sets of data from third party sources, including individual or regional benchmark providers. Benchmark provider may contact and gather data from each of the identified third party sources (S.56). Various conditions may apply to collect the data from third party sources. For example, the benchmark provider may guarantee confidentiality to a third party source in a similar manner to that provided to customers. In addition, the data collected from a third party source may be fee based, in which case any such fees or purchase costs are paid by the benchmark provider.

Consistent with embodiments of the invention, collected data from customers and/or third party sources may be used to populate the benchmark database (S.58). As part of this process, the data may be processed and validated. For example, in order to ensure reliability of the database, the validity of collected data may be checked. Various approaches may be used to perform validation. For example, collected data may be analyzed and compared to thresholds, ranges or averages compiled for comparable data collected for the database. Thus, certain data may only be deemed “valid” if it is within computed averages for similar data reported by competitors or peer groups. For instance, a measure of “10 days” may be deemed invalid if the average for comparable data is “2 hours”. Alternatively, valid ranges or thresholds may be computed to check the validity of the data. Any invalid data may be removed and not contributed to the database. As will be appreciated by those skilled in the art, the above examples are illustrative, and other validation techniques may be employed in the invention.

In addition to validating the data, the benchmark provider may process the data so that it is placed in a predetermined format. Consistent with an embodiment of the invention, one or more predetermined data formats may be used by the benchmark provider to facilitate the electronic exchange and storage of benchmark data. The predetermined data format(s) may be consistent with an extrinsic standard of a software vendor (such as SAP AG) or another entity which defines an electronic data structure for storing or handling benchmark data within a software-based environment or application. The software-based environments or applications may be utilized by customers to support business processes and may comprise, for example, enterprise resource planning software or strategic enterprise management software. By way of example, the predetermined format may be consistent with a SAP® business warehouse (BW), Infocube designed for SAP® systems and software environments. Further, the data may be processed and assigned various attributes (e.g., company size, industry, region, etc.) and benchmark calculations may be made. Also, any confidential information of the customer or third party may be removed or deleted.

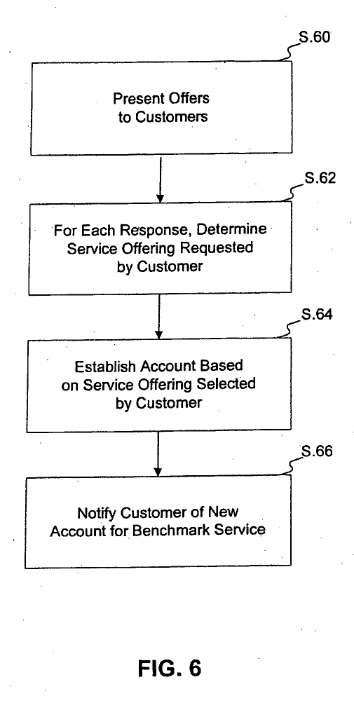

FIG. 6 is a flowchart of an exemplary method for presenting offers to customers and providing benchmark services to customers. As illustrated in FIG. 6, offers for benchmark services may be presented to customers (S.60). The offers may be presented to customers who submitted data to the benchmark provider, as well as customers who did not receive a request for data or were not willing to submit data. In addition, the customers that receive the offers may be existing, new or potential customers of the benchmark provider.

Consistent with embodiments of the invention, the offers presented to customers may take various forms. For example, the offer may be in the form of a solicitation, an advertisement, a promotion, an invitation letter or any other form of an offer. In one embodiment, the offer includes a service contract with one or more service offerings that can be accepted by a customer.

Offers may be presented to customers using various approaches. For example, electronic presentations (e-mail, pop-up or banner advertisements, etc.) and/or printed presentations (letters, flyers, solicitations) may be utilized. In the case of printed media, the offers may be sent by mail, posted or distributed by any suitable means.

As disclosed herein, offers sent to customers may comprise a service contract. The service contract offer may permit a customer to accept a benchmark data service and/or other services from the benchmark provider. Further, the offer for benchmark data services may include different service level options. These services levels may vary according to data volume usage or level of sophistication. In addition, the predetermined fees or service charges for each service option may be indicated in the offer presented to the customer. Consistent with embodiments of the invention, services fees can take any form, such as flat fees, usage fees, and the like.

For each offer accepted by a customer, a determination is made of the service(s) requested by the customer (S.62). In one embodiment, a customer is permitted to selected one or more service offerings from the benchmark provider, provided that they are not conflicting or inconsistent. Thus, for example, the customer may request a benchmark data service and another service (.e., periodic industry reports) from the provider.

To request or order services, a customer may provide a response to the benchmark provider. The response may be sent in response to the offer from the benchmark provider and identify the service(s) that the customer is interested in receiving. The response from a customer may be presented to the benchmark provider using various methods, including electronic communication (email, submission of a response page on a web site, etc.) and/or other means (mailed response card, verbal instructions by telephone, etc.). As will be appreciated by those skilled in the art, the above-listed approaches are merely examples, and other methods may be employed according to the needs of the benchmark system or environment.

For each new customer, an account may be established. (S.64). Customer account information may be stored in a memory device or as part of a customer database. Each customer account may include various information, including the customer's name and billing address. The account information may also include a list of the service(s) elected by the customer, as well as their associated fees. If the customer responded to a specific promotion, then information identifying the applicable discount or other incentive may be recorded in the customer account.

As further shown in FIG. 6, each customer may be notified of their new account information (S.66). The notification may include information concerning the service(s) elected by the customer. Such information may indicate the rules and/or procedures associated with each service. In addition, for purposes of data security, each customer may be assigned or required to elect a username and password to log-on to a secure web site, access account information, etc. Other conventional security measures may be implemented, as needed. Once the customer is set-up, the benchmark data and/or other elected service(s) may be provided to the customer.

While certain embodiments and implementations have been described with reference to the drawings, other embodiments and implementations of the invention are possible. For example, to provide a predetermined data format for benchmark data, various electronic data structures may be employed. In one embodiment, the electronic data structure is defined as an XML file or an HTML file. Examples of electronic data structures and protocols that may be used in embodiments of the present invention to facilitate the handling and exchange of benchmark data are disclosed in the following co-pending, PCT international applications: PCT/EP 03/01423; PCT/EP 03/01436; PCT/EP 03/01433; PCT/EP 03/01422; PCT/EP 03/01434; PCT/EP 03/01421; PCT/EP 03/01438, all of which were filed on Feb. 13, 2003 by the assignee of this application. The disclosures of the above-referenced PCT applications are expressly incorporated herein by reference in their entireties.

Further, to facilitate benchmark exchange and analysis functionality, various software components may be provided for use by the benchmark provider and/or customers. For example, in one embodiment, measure builder software may be provided to facilitate the definition, description and analysis of measures (i.e., benchmark definitions). A measure builder application may be adapted to provide maintenance and analysis of benchmark data as well. In addition, measure catalogs may be defined, such as a customer defined catalog of measures maintained by the measure builder software. A default or ready to use measure catalog (referred to as “Business Content”) can also be used. By way of example, SAP® software components such as SAP® SEM Measure Builder and SEM Measure Catalog may be used in implementations of the present invention.

As disclosed herein, embodiments and features of the invention may be implemented through computer-hardware and/or software. Such embodiments may be implemented in various environments, such as networked and computing-based environments with one or more users. The present invention, however, is not limited to such examples, and embodiments of the invention may be implemented with other platforms and in other environments.

By way of example, embodiments of the invention may be implemented using conventional personal computers (PCs), desktops, hand-held devices, multiprocessor computers, pen computers, microprocessor-based or programmable consumer electronics devices, minicomputers, mainframe computers, personal mobile computing devices, mobile phones, portable or stationary personal computers, palmtop computers or the like.

The storage mediums and databases referred to herein symbolize elements that temporarily or permanently store data and instructions. Although storage functions may be provided as part of a computer, memory functions can also be implemented in a network, processors (e.g., cache, register), or elsewhere. While examples of databases have been provided herein, various types of storage mediums can be used to implemented features of the invention, such as a read only memory (ROM), a random access memory (RAM), or a memory with other access options. Further, memory functions may be physically implemented by computer-readable media, such as, for example: (a) magnetic media, like a hard disk, a floppy disk, a magnetic disk, a tape, or a cassette tape; (b) optical media, like an optical disk (e.g., a CD-ROM), or a digital versatile disk (DVD); (c) semiconductor media, like DRAM, SRAM, EPROM, EEPROM, memory stick, and/or by any other media, like paper.

Embodiments of the invention may also be embodied in computer program products that are stored in a computer-readable medium or transmitted using a carrier, such as an electronic carrier signal communicated across a network between computers or other devices. In addition to transmitting carrier signals, network environments may be provided to link or connect components in the disclosed systems. Networking environments are commonplace in offices, enterprise-wide computer networks, intranets and the Internet (i.e., the World Wide Web). The network can be a wired or a wireless network. To name a few network implementations, the network is, for example, a local area network (LAN), a wide area network (WAN), a public switched telephone network (PSTN), an Integrated Services Digital Network (ISDN), an infra-red (IR) link, a radio link, such as a Universal Mobile Telecommunications System (UMTS), Global System for Mobile Communication (GSM), Code Division Multiple Access (CDMA), or a satellite link.

Transmission protocols and data formats are also known, for example, as transmission control protocol/internet protocol (TCP/IP), hyper text transfer protocol (HTTP), secure HTTP, wireless application protocol, unique resource locator (URL), unique resource identifier (URI), hyper text markup language (HTML), extensible markup language (XML), extensible hyper text markup language (XHTML), wireless application markup language (WML), Standard Generalized Markup Language (SGML), etc. Such features may be utilized to implement embodiments of the present invention, as disclosed herein.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A method for providing benchmark services to customers, the method comprising:
collecting data from a plurality of customers;
processing collected data from each customer to determine if the data is valid;
building a comprehensive benchmark database based on the collected data that is determined to be valid, the comprehensive benchmark database including data for at least a plurality of different functional areas;
presenting offers to customers, the offers including the option to select at least one type of benchmark service to receive data from the comprehensive benchmark database; and
providing benchmark services to customers in accordance with the benchmark services selected by each customer.

2. A method for providing benchmark services according to claim 1, wherein collecting comprises presenting requests for data to the plurality of customers, wherein each request for data includes a request to submit data for the benchmark database.

3. A method for providing benchmark services according to claim 2, wherein the selected services are provided by a benchmark provider and further wherein the request for data is made optional to each customer such that the customer may decline the request and still receive services from the benchmark provider.

4. A method for providing benchmark services according to claim 3, wherein the request for data includes a guarantee from the benchmark provider to maintain the confidentiality of the data provided by the customer.

5. A method for providing benchmark services according to claim 2, wherein the request for data includes an incentive offered to the customer in return for contributing data, the incentive comprising at least one of: a payment, a discount on benchmark services, and a complimentary benchmark service.

6. A method for providing benchmark services according to claim 1, further comprising collecting data for the comprehensive benchmark database from a plurality of third party sources.

7. A method for providing benchmark services according to claim 6, wherein the plurality of third party sources comprise data collection channels or sources of third parties to populate the benchmark database.

8. A method for providing benchmark services according to claim 1, wherein processing collected data from each customer to determine if the data is valid comprises validating data when the data is determined to be within an average for comparable data submitted by other customers.

9. A method for providing benchmark services according to claim 1, wherein the plurality of functional areas comprises at least one of: financials (FIN), customer relationship management (CRM), supply chain management (SCM), supplier relationship management (SRM), and human resources (HR).

10. A method for providing benchmark services according to claim 1, wherein building the comprehensive benchmark database comprises building a large-scale database with benchmark data for a plurality of functional areas and for different types of industries and company sizes.

11. A method for providing benchmark services according to claim 1, further comprising formatting collected data in accordance with an extrinsic standard, the extrinsic standard defining an electronic data structure for storing benchmark data.

12. A method for providing benchmark services according to claim 11, wherein the extrinsic standard facilitates the transfer of benchmark data to the customer.

13. A method for providing benchmark services according to claim 1, further comprising establishing a benchmark provider for providing the benchmark services to customers.

14. A method for providing benchmark services according to claim 13, wherein the benchmark provider is established as a business entity of a company with an existing base of customers, and further wherein collecting comprises collecting data from the existing customer base of the company.

15. A method for providing benchmark services to customers, the benchmark services being provided by a benchmark provider, the method comprising:
presenting requests for benchmark data to a plurality of customers, each request including a request to contribute data that may be declined by a customer without affecting the customer's ability to receive benchmark services from the benchmark provider;
collecting data from each of the plurality of customers who accept the request to contribute data;
building a benchmark database based on the data collected from the plurality of customers, wherein data from the benchmark database provides support for the benchmark services;
presenting offers to customers, the offers including the option to select at least one type of benchmark service; and
providing benchmark services to customers in accordance with the benchmark services selected by each customer.

16. A method for providing benchmark services according to claim 15, wherein the request for data includes a guarantee from the benchmark provider to maintain the confidentiality of the data provided by the customer.

17. A method for providing benchmark services according to claim 15, wherein the request for data includes an incentive offered to the customer in return for contributing data, the incentive comprising at least one of: a payment, a discount on benchmark services, and a complimentary benchmark service.

18. A method for providing benchmark services according to claim 15, wherein the benchmark database is a comprehensive benchmark database, the comprehensive benchmark database comprising data for at least one of: a plurality of functional areas, a plurality of industries, and a plurality of company sizes.

19. A method for providing benchmark services according to claim 18, wherein the plurality of functional areas comprises at least one of: financials (FIN), customer relationship management (CRM), supply chain management (SCM), supplier relationship management (SRM), and human resources (HR).

20. A method for providing benchmark services according to claim 15, further comprising formatting collected data in accordance with an extrinsic standard, the extrinsic standard defining an electronic data structure for storing benchmark data.

21. A method for providing benchmark services according to claim 20, wherein the extrinsic standard facilitates the transfer of benchmark data between the benchmark provider and the customer.

22. A method for providing benchmark services according to claim 15, further comprising establishing the benchmark provider as a business entity of a company with an existing customer base, and wherein presenting requests comprises presenting requests for data to the existing customer base of the company.

23. A method for providing benchmark services according to claim 15, further comprising collecting data for the benchmark database from a plurality of third party sources.

24. A method for providing benchmark services according to claim 23, wherein the plurality of third party sources comprise data collection channels or sources of third parties to populate the benchmark database.

25. A method for providing benchmark services according to claim 15, further comprising determining if collected data from each customer is valid, and wherein building a benchmark database comprises building the benchmark database only based on collected data from customers that is determined to be valid.

26. A method for providing benchmark services according to claim 15, further comprising collecting data from a plurality of third party resources, wherein building the benchmark database comprises populating the database with the data collected from the plurality of customers and third party resources to provide a large-scale benchmark database.

27. A method for providing benchmark services according to claim 15, wherein providing benchmark services comprises creating a customer account for each customer, the customer account including information indicating the services selected by the customer.

28. A system for providing benchmark services to customers, the system comprising:
a comprehensive benchmark database comprising benchmark data for at least one of: a plurality of functional areas, a plurality of industries, and a plurality of company sizes; and
a benchmark system adapted to administer and provide benchmark services to customers, wherein the benchmark services are supported by the comprehensive benchmark database, the benchmark system comprising:
data collection and management means for collecting data for the comprehensive benchmark database; and
data exchange means for providing benchmark data to a customer in accordance with a service offering selected by the customer.

29. A system for providing benchmark services according to claim 28, wherein the comprehensive benchmark database comprises benchmark data that is stored in accordance with an extrinsic standard, the extrinsic standard defining an electronic data structure for storing benchmark data.

30. A system for providing benchmark services according to claim 28, wherein the plurality of functional areas comprises at least one of: financials (FIN), customer relationship management (CRM), supply chain management (SCM), supplier relationship management (SRM), and human resources (HR).

31. A system for providing benchmark services according to claim 30, wherein the comprehensive benchmark database comprises data that is robust and not influenced by location or regional dependencies of the data.

32. A system for providing benchmark services according to claim 28, wherein the data collection and management means comprises means for presenting requests for benchmark data to a plurality of customers, each request including a request to contribute data that may be declined by a customer without affecting the customer's ability to received benchmark services from the benchmark provider.

33. A system for providing benchmark services according to claim 32, wherein the data collection and management means further comprises means for collecting data from each of the plurality of customers who accepted the request to contribute data.

34. A system for providing benchmark services according to claim 33, wherein the data collection and management means further comprises means for collecting data from third party sources, the third party sources comprising data collection channels or sources of third parties to populate the benchmark database.

35. A system for providing benchmark services according to claim 32, wherein the request to contribute data includes a guarantee to maintain the confidentiality of the data provided by the customer.

36. A system for providing benchmark services according to claim 32, wherein the request to contribute data includes an incentive offered to the customer in return for contributing data.

37. A system for providing benchmark services according to claim 28, wherein the benchmark system further comprises administrative means for providing administrative support for the benchmark services provided to customers.

38. A system for providing benchmark services according to claim 37, wherein the administrative means comprises means creating a customer account for each customer, the customer account including information indicating the services selected by the customer.

39. A system for providing benchmark services according to claim 28, wherein the data collection and management means comprises means for formatting collected data in accordance with an extrinsic standard, the extrinsic standard defining an electronic data structure for storing benchmark data.

40. A system for providing benchmark services according to claim 39, wherein the extrinsic standard facilitates the transfer of benchmark data between the benchmark provider and the customer.

41. A system for providing benchmark services, the system comprising:
means for collecting data from a plurality of customers;
means for building a comprehensive benchmark database based on the data collected from the plurality of customers, the comprehensive benchmark database including data for at least a plurality of functional areas;
means for presenting offers to customers, the offers including the option to select at least one type of benchmark service to received data from the comprehensive benchmark database; and
means for providing benchmark services to customers in accordance with the benchmark services selected by each customer.

42. A system for providing benchmark services according to claim 41, wherein the means for collecting comprises means for presenting requests for data to the plurality of customers, wherein each request for data includes a request to submit data for the benchmark database.

43. A system for providing benchmark services according to claim 42, wherein the selected services are provided by a benchmark provider and further wherein the request for data is made optional to each customer such that the customer may decline the request and still receive services from the benchmark provider.

44. A system for providing benchmark services according to claim 43, wherein the request for data includes a guarantee from the benchmark provider to maintain the confidentiality of the data provided by the customer.

45. A system for providing benchmark services according to claim 42, wherein the request for data includes an incentive offered to the customer in return for contributing data, the incentive comprising at least one of: a payment, a discount on benchmark services, and a complimentary benchmark service.

46. A system for providing benchmark services according to claim 41, further comprising means for collecting data for the comprehensive benchmark database from a plurality of third party sources.

47. A system for providing benchmark services according to claim 41, wherein the plurality of functional areas comprises at least one of: financials (FIN), customer relationship management (CRM), supply chain management (SCM), supplier relationship management (SRM), and human resources (HR).

48. A system for providing benchmark services according to claim 41, wherein the means for building the comprehensive benchmark database comprises means for building a large-scale database with benchmark data for a plurality of functional areas and for different types of industries and company sizes.

49. A system for providing benchmark services according to claim 41, further comprising means for formatting collected data in accordance with an extrinsic standard, the extrinsic standard defining an electronic data structure for storing benchmark data.

50. A system for providing benchmark services according to claim 49, wherein the extrinsic standard facilitates the transfer of benchmark data to the customer.

51. A system for providing benchmark services according to claim 41, wherein the benchmark services are provided to customers by a benchmark provider, and further wherein the benchmark provider is a business entity of a company with an existing customer base.

52. A system for providing benchmark services according to claim 51, further comprising means for collecting data from the existing customer base of the company.

53. A system for providing benchmark services according to claim 51, further comprising means for validating collected data from each customer to determine if the data is valid, and wherein the building means only uses collected data that is determined to be valid for building the database.
